(19) United States
(12) Patent Application Publication
(10) Pub. No.: US 2023/0264229 A1
(43) Pub. Date: Aug. 24, 2023

(54) Polymer Reinforced Screening Panel

(71) Applicant: Polydeck Screen Corporation, Spartanburg, SC (US)

(72) Inventors: Ryan Johnson, Moore, SC (US); Peter Helmut Franz Freissle, Spartanburg, SC (US)

(21) Appl. No.: 18/309,348

(22) Filed: Apr. 28, 2023

Related U.S. Application Data
(63) Continuation-in-part of application No. 16/923,663, filed on Jul. 8, 2020, now Pat. No. 11,654,455.
(60) Provisional application No. 62/871,294, filed on Jul. 8, 2019.

(51) Int. Cl. B07B 1/46; B07B 1/28

(52) U.S. Cl. CPC B07B 1/469; B07B 1/28; B07B 2201/02

(57) ABSTRACT

A screen panel for a vibratory machine includes a polymer layer comprising a resilient material and defining a plurality of panel apertures extending through the polymer layer from an upper screening surface to a bottom surface of the polymer layer, each of the plurality of panel apertures defining an aperture perimeter. The screen panel includes a reinforcing structure having a top surface that supports at least a portion of the bottom surface of the polymer layer, wherein the reinforcing structure is positioned under the polymer layer along only a portion of the aperture perimeter of each of the plurality of panel apertures.

### CROSS-REFERENCE TO RELATED APPLICATIONS

This application is a continuation in part of U.S. application Ser. No. 16/923,663, filed Jul. 8, 2020, titled “Polymer Reinforced Screening Panel,” which claims priority to U.S. Provisional Patent Application Ser. No. 62/871,294 having a filing date of Jul. 8, 2019, titled “Polymer Reinforced Screening Panel,” both of which are incorporated herein by reference in their entirety for all purposes.

### FIELD

The present disclosure relates generally to screening systems, and more particularly to screening systems for vibratory machines.

### BACKGROUND

Screening systems are used in the mining and other industries to size and separate desired materials from less desired materials. Certain screening systems include modular screening systems which are composed of a plurality of modular and replaceable screening media (e.g., screen panels) mounted to a support frame. The screening media includes a plurality of apertures dimensioned to separate the desired material from less desired material.

Screening media can include modular screen panels which are removably mountable to a support frame. The individual screen panels can be constructed of a frame or insert that is encapsulated by a resilient material, such as a polymeric material, such as polyurethane or rubber. The individual screen panels can be mounted to the support frame and subjected to intense vibrations during the screening process. As materials are passed over the surface of the screen panels, desired materials pass through the apertures of the screen panels.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a screen panel according to example embodiments of the present disclosure;

FIG. 2 depicts a cutaway view taken along section line A-A of FIG. 1 according to example embodiments of the present disclosure;

FIG. 3 depicts a cross-sectional view of a screen panel according to example embodiments of the present disclosure;

FIG. 4 depicts another cross-sectional view of a screen panel according to example embodiments of the present disclosure;

FIG. 5 depicts a partial view of a first screen panel and a second screen panel of a screening system according to example embodiments of the present disclosure;

FIG. 6 depicts side view of a screen panel of a screening system according to example embodiments of the present disclosure;

FIG. 7 depicts top view of a screen panel of a screening system according to example embodiments of the present disclosure;

FIG. 8. depicts another example screen panel of a screen system according to example embodiments of the present disclosure;

FIG. 9 depicts a cross sectional view of a screen panel including an overhang portion according to example embodiments of the present disclosure;

FIG. 10 depicts a cross sectional screen panel including a polymer layer and reinforcing structure according to example embodiments of the present disclosure;

FIG. 11 depicts another cross sectional view of the exemplary screen panel of FIG. 10 according to example embodiments of the present disclosure; and

FIG. 12 depicts a bottom view of a screen panel including a polymer layer and reinforcing structure according to example embodiments of the present disclosure.

### SUMMARY

Advantages of the invention will be set forth in part in the following description, or may be apparent from the description, or may be learned through practice of the invention.

In one exemplary embodiment, a screen panel for a vibratory machine is provided including a polymer layer comprising a resilient material and defining a plurality of panel apertures extending through the polymer layer from an upper screening surface to a bottom surface of the polymer layer, each of the plurality of panel apertures defining an aperture perimeter and a reinforcing structure having a top surface that supports at least a portion of the bottom surface of the polymer layer, wherein the reinforcing structure is positioned under the polymer layer along only a portion of the aperture perimeter of each of the plurality of panel apertures.

In another exemplary embodiment, a screen panel for a vibratory machine is provided including a reinforcing structure having a top surface and a reinforcement aperture defined therethrough, the reinforcement aperture defining a reinforcement aperture width; and a polymer layer comprising a resilient material and having a bottom surface that is arranged over the top surface of the reinforcing structure, wherein the polymer layer has a panel aperture defined therethrough, the panel aperture defining an aperture entry width, and wherein the polymer layer further defines an overhang portion that extends at least partially beyond an edge of the reinforcing structure such that the aperture entry width is less than the reinforcement aperture width.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

Example aspects of the present disclosure are directed to screen panels for use in screening systems. Screen panels for screening systems, in some cases, have a need to be strong and long-lasting. Conventional screen panels for screening systems can include a frame formed from a structural material, such as metals or polymer composites. Furthermore, the frame can be surrounded by a wear resistant polymer layer. The wear resistant polymer layer can cover the frame and form bridges that define screening apertures. Over the years, screen panels have evolved to have more open area. However, the requirement that screen panels be both strong and long-lasting can limit an amount of space available for the screening apertures.

Example aspects of the present disclosure are directed to a screen panel for a vibratory machine. The screen panel can include a reinforcing structure having a top surface. The reinforcing structure can define a plurality of apertures through the reinforcing structure. The screen panel can include a polymer layer having a bottom surface that is arranged over the top surface of the reinforcing structure. The polymer layer can define a plurality of apertures therethrough. Each aperture of the plurality of apertures of the polymer layer can be aligned with a single respective aperture of the plurality of apertures of the reinforcing structure. In some embodiments, the polymer layer can include a resilient material.

The reinforcing polymer structure can include a first plurality of bridge elements and a second plurality of bridge elements. The first plurality of bridge elements and the second plurality of bridge elements can intersect one another to define a plurality of openings. The screen panels can further include a wear resistant polymer material formed from a second material that is different than the first material. The wear resistant polymer layer can at least partially cover the reinforcing polymer structure. For instance, the wear resistant polymer layer can cover a top portion of the reinforcing polymer structure. More specifically, the wear resistant polymer layer can cover a top surface of both the first plurality of bridge elements and the second plurality of bridge elements, respectively. Furthermore, each of a plurality of screening apertures defined by the wear resistant polymer material can be aligned with a corresponding opening of the plurality of openings defined by the reinforcing polymer structure.

In some embodiments, the polymer layer can cover all of the top surface of the reinforcing structure.

In some embodiments, the reinforcing structure can include a first group of bridge elements elongated along a transverse direction and spaced apart from one another along a lateral direction; and a second group of bridge elements elongated along the lateral direction and spaced apart from one another along the transverse direction. The first group of bridge elements and the second group of bridge elements can define respective perimeters of the reinforcing structure along the top surface of the reinforcing structure. The polymer layer can cover all respective portions of the top surface of the reinforcing structure located on each bridge element of the first group of bridge elements and covers all respective portions of the top surface of the reinforcing structure located on each bridge element of the second group of bridge elements.

In some embodiments, the reinforcing structure can be bonded to the polymer layer along respective portions of the top surface of the reinforcing structure that are located on each bridge element of the first group of bridge elements; and the reinforcing structure can be bonded to the polymer layer along respective portions of the top surface of the reinforcing structure that are located on each bridge element of the second group of bridge elements.

In some embodiments, the reinforcing structure can be bonded to the polymer layer. Example bonding processes can include mechanical adhesion, dispersive adhesion (e.g., Van Der Waals Forces), electrostatic adhesion, specific adhesion (e.g., hydrogen bonding), chemical adhesion (e.g., ionic or covalent bonding), diffusion adhesion (e.g., interdiffusion, entanglement, intermingling, or physical crosslinking). As additional examples an adhesive material can be used to bond the reinforcing structure to the polymer layer. As further examples, the reinforcing structure can be over-molded, printed, or otherwise deposited or formed on the polymer layer.

The reinforcing structure can include a variety of materials. In some embodiments, the reinforcing structure can include at least one of polyethylene, polypropylene, polyamide, acrylonitrile butadiene styrene (ABS), polycarbonate, polybutylene terephthalate (PBT), polyester, resin, or a blend thereof. In some embodiments, the reinforcing structure can include at least one of glass fiber or carbon fiber. According to example embodiments, the reinforcing structure may be made from injection molded high strength engineering polymer to offer the combination of cost efficiency and design flexibility required by this architecture. Preferably, this high strength engineering polymer will be from a family of polyamide (PA or Nylon) or more preferably polyphthalamide (PPA) polymers or blends thereof. Moreover, to ensure adequate stiffness and strength of this polymer, it is preferred that the polymer compound contain a reinforcing fiber additive such as carbon fiber, glass fiber, aramid fiber, or similar.

In some embodiments, the resilient material of the polymer layer can include at least one of a urethane elastomer or a vulcanized rubber. According to example embodiments, vulcanized rubber may be an ideal top polymer layer due to its combination of wear resistance and flexibility. A variety of vulcanized rubber materials can be used with durometer ranges from 40-70 Shore A and a range of natural rubber content between 20-100%.

Within these polymer options it may be desirable that the polymer used for the reinforcing structure have the proper combination of stiffness, strength, moisture resistance, and temperature resistance. The temperature resistance is of particular importance because of the curing process required by the vulcanized rubber top polymer layer. The vulcanization process requires temperatures of up to 350 degrees Fahrenheit and the reinforcing structure must remain stable during this curing process. Thus, it is desirable that the reinforcing structure polymer resists distortion at high temperatures.

Moreover, screen panels are often used in wet conditions. The presence of moisture can affect the strength and stiffness of certain types of PA or PPA materials. PPA materials are less prone to the reduction in stiffness and strength than PA materials in wet conditions. Thus, in order to make a reinforcing structure that is resilient in high moisture conditions, PPA or PA/PPA polymers are the preferred material.

Furthermore, it is preferred that the vulcanized rubber top polymer layer be bonded to the PA/PPA reinforcing structure. A mechanical bond can be developed by abrading and cleaning the reinforcing structure surface prior to the rubber molding process. Furthermore, this bond can be enhanced through chemical bonds formed between the vulcanized rubber and the reinforcing structure during the rubber curing process. A bonding agent or adhesive can also be applied to the reinforcing structure to enhance the bonding of the rubber top polymer layer to the reinforcing structure.

Thus, an embodiment of the present subject matter includes an injection molded reinforcing structure comprising a PA/PPA polymer with reinforcing fiber overmolded with a vulcanized rubber top polymer layer that is chemically bonded to the surface of the reinforcing structure. The reinforcing structure may be positioned underneath at least a portion of the aperture bridges.

More specifically, the reinforcing structure may be comprised of a series of primary bridges and (optionally) secondary bridges. Primary bridges are defined as the bridges that run between the panel edges that incorporate fastening features while secondary bridges are bridges that connect other elements of the reinforcing structure.

Example aspects of the present disclosure are directed to a screening system for a vibratory machine. The screening system can include a first screen panel comprising a plurality of bridge elements that define a plurality of apertures therethrough in a vertical direction. The first screen panel can have a plurality of edges. The first screen panel can have a plurality of partial bridge elements extending away from the first screen panel from at least one edge of the plurality of edges of the first screen panel in a lateral direction perpendicular to the vertical direction. A second screen panel can include a plurality of bridge elements that define a plurality of apertures therethrough in a vertical direction. The second screen panel can have a plurality of edges. The second screen panel can have a plurality of partial bridge elements extending away from the second screen from at least one edge of the plurality of edges in the lateral direction. Each of the plurality of partial bridge elements of the second screen panel can be aligned with respective ones of the plurality of partial bridge elements of the first screen panel to form at least one aperture in the vertical direction at an intersection of the first screen panel and the second screen panel.

In some embodiments, respective end faces of the plurality of partial bridge elements of the second screen panel can contact respective end faces of respective ones of the plurality of partial bridge elements of the first screen panel.

In some embodiments, each of the plurality of partial bridge elements of the second screen panel are aligned with respective ones of the plurality of partial bridge elements of the first screen panel such that the at least one aperture includes a plurality of apertures at the intersection of the first screen panel and the second screen panel.

In some embodiments, the first screen panel can include an additional plurality of partial bridge elements extending away from the first screen panel in a transverse direction from an additional edge of the plurality of edges. The transverse direction can be perpendicular to each of the lateral direction and a vertical direction.

In some embodiments, the additional edge of the plurality of edges of the first screen panel can be parallel and opposite to the at least one edge of the plurality of edges of the first screen panel.

In some embodiments, the plurality of partial bridge elements of the first screen panel define a portion of a perimeter of the first screen panel when viewed from the vertical direction.

In some embodiments, the plurality of partial bridge elements of the second screen panel can define a portion of a perimeter of the second screen panel when viewed from the vertical direction.

In some embodiments, at least one of the first screen panel or the second screen panel can include a frame member extending in a transverse direction. The transverse direction can be perpendicular to each of the lateral direction and a vertical direction. Each of the plurality of partial bridge elements of the first screen panel can extend downward in the vertical direction away from a top surface of the first screen panel and connect with the frame member to form at least one lateral aperture at the intersection of the first screen panel and the second screen panel. The lateral aperture(s) can extend in the lateral direction.

In some embodiments, a support structure can be arranged below the first screen panel and second screen panel in the vertical direction. The frame member can contact the support structure to support the first screen panel and second screen panel.

In some embodiments, each of the first screen panel and the second screen panel can include respective frame members extending in the transverse direction. The respective frame members can be aligned in the lateral and transverse directions.

In some embodiments, each of the plurality of partial bridge elements of the first screen panel extend downward in the vertical direction away from a top surface of the first screen panel and connect with the frame member of the first screen panel to define at least one lateral aperture at the intersection of the first screen panel and the second screen panel. The lateral aperture(s) can extend in the lateral direction. Each of the plurality of partial bridge elements of the second screen panel extend downward in the vertical direction away from a top surface of the second screen panel and connect with the frame member of the second screen panel.

In some embodiments, at least one of the first screen panel or the second screen panel can include a reinforcing structure having a top surface. The reinforcing structure can define a plurality of apertures through the reinforcing structure. A polymer layer can have a bottom surface that is arranged over the top surface of the reinforcing structure. The polymer layer can defines a plurality of apertures therethrough. Each aperture of the plurality of apertures of the polymer layer can be aligned with a single respective aperture of the plurality of apertures of the reinforcing structure. The polymer layer can include a resilient material.

Example aspects of the present disclosure are directed to a screen panel for a vibratory machine. The screen panel can include a reinforcing structure including a first plurality of bridge elements having respective top surfaces and a second plurality of bridge elements having respective top surfaces. The second plurality of bridge elements can intersect the first plurality of bridge elements to define a plurality of apertures. A polymer layer can define a plurality of apertures therethrough. The polymer can be arranged over the reinforcing structure such that the polymer layer covers all respective top surfaces of the first plurality of bridge elements and covers all respective top surfaces of the second plurality of bridge elements.

The first material used to form the reinforcing polymer structure can include any suitable type of polymer having a sufficiently high tensile strength or flexural modulus. For instance, the polymer can include, without limitation, polyethylene, polypropylene, polyamide, acrylonitrile butadiene styrene (ABS), polycarbonate, polybutylene terephthalate (PBT), or polyester. In some implementations, the first material can be a neat resin. Alternatively, the first material can include a blend of polymers.

The second material used to form the wear resistant polymer layer can include any suitable type of polymer known to resist wear imparted by the materials being screened, such as abrasive wear and erosive wear. Polymers having such properties can be elastomeric with relatively low modulus values, high elongation capacity, and high resistance to tearing. Example polymers can include urethane elastomers or vulcanized rubbers.

In some implementations, the first material used to form the reinforcing polymer structure can include one or more reinforcements, fillers, and/or additives. Example reinforcements include fibers such as glass fiber, carbon fiber, or aramid fiber. Fillers can include calcium carbonate, silica, coal fly ash, or other common materials. Additives may include materials designed to enhance the bonding of the reinforcement to the wear resistant polymer material. In some implementations, the one or more fillers can be processed via any suitable type of injection molding process.

In some implementations, the wear resistant polymer layer can be bonded to the upper portion of the reinforcing polymer structure. More specifically, the wear resistant layer can be bonded to the top surface of both the first plurality of bridge elements and the second plurality of bridge elements, respectively. In this manner, the wear resistant polymer layer covering the top portion of the reinforcing polymer structure can define the size and shape of the plurality of screening apertures of the screen panel. In addition, the wear resistant polymer layer can protect the top portion of the reinforcing polymer structure from wear (e.g., abrasive wear, erosive wear).

In some implementations, the wear resistant polymer layer can also cover the bottom portion of the reinforcing polymer structure. In this manner, the wear resistant polymer layer can also protect the bottom portion of the reinforcing polymer structure from wear. Alternatively or additionally, the wear resistant polymer layer can cover one or more sides of the reinforcing polymer structure extending between the upper portion and the bottom portion. In this manner, the wear resistant polymer layer can also protect the one or more sides of the reinforcing polymer structure from wear.

In some implementations, the wear resistant polymer layer can include one or more fasteners. In such implementations, the screen panel can be attached to a support frame via the one or more fasteners. Alternatively or additionally, the reinforcing polymer structure can span between support frame members of a screen deck. In this manner, the reinforcing polymer structure can provide support for the screen panel. In addition, the reinforcing polymer structure provides support for the wear resistant polymer layer.

Example screen panels of the present disclosure can provide numerous technical benefits. For instance, as discussed above, the wear resistant polymer layer can be bonded to the upper portion of the reinforcing polymer structure. In this manner, each of the plurality of bridges of the screen panels can include the first material used to form the reinforcing polymer structure and the second material used to form the wear resistant polymer layer. In this manner, the dimensions (e.g., width, thickness, etc.) of each of the plurality of bridge elements can be reduced, because the strength and stiffness of each bridge is improved via the first material. Furthermore, the reinforcing polymer structure allows the overall panel loads to be carried without requiring additional components (e.g., support frames). In this manner, an amount of space on the screen panel that can be used for screening can be increased. This enables higher throughput of material through a given screen panel. Another added benefit is that the weight of the screen panel can be reduced due, at least in part, to the reinforcing polymer structure weighing less than frames used in conventional screen panels. In this manner, the weight added by screen panels of the present disclosure place on a vibratory screening machine can be reduced compared to conventional screen panels.

Example aspects of the present disclosure are directed to modular screen panels for screening systems. Conventional modular screen panels do not provide as much open area or as many screening apertures as other conventional screening media (e.g., wire cloth). This is due to the fact that a portion of the open area is occupied by fasteners configured to couple the screen panel to a screen deck of the screening system. Although changes have been implemented to reduce the amount of space these fasteners, a portion of the open area remains occupied by the fasteners.

Example aspects of the present disclosure can include a modular screen panel having a screening surface that is elevated relative to a screen deck of a screening system. For instance, in some implementations, a plurality of bridge elements defining, at least in part, a plurality of screening apertures in the screening surface can extend from the screening surface and connect to the screen deck. In this manner, the modular screen panel can be coupled to the screen deck without consuming any additional platform area from the screening surface of the modular screen panel.

In some implementations, the plurality of bridge elements extending from the screening surface to connect to the screen deck can include projections or features configured to engage a corresponding projection or features associated with the screen deck. Alternatively or additionally, the plurality of screening apertures can extend from the screening surface such that the screening surface is elevated relative to the screen deck by a predetermined amount. For instance, in some implementations, the predetermined amount can correspond to a minimum dimension of the plurality of screening apertures.

In some implementations, the modular screen panel can be a borderless screen panel. More specifically, the perimeter of the modular screen panel can be defined by the plurality of bridge elements. When mounted on the support deck, the plurality of bridge elements of the modular screen panel can connect to corresponding bridge elements of adjacent panels to define additional screening apertures. In this manner, the number of screening apertures of the modular screening panel can be increased, because the perimeter of the modular screening panel is no longer occupied by the fastener(s).

In some embodiments, perpendicular edges of the same screen panel can define partial bridge elements such that apertures are formed between the screen panel and multiple other screen panels. For example, the first screen panel can include an additional plurality of partial bridge elements extending away from the first screen panel in a transverse direction from an additional edge of the plurality of edges. The transverse direction can be perpendicular to each of the lateral direction and a vertical direction. A third screen panel can include a plurality of partial bridge elements aligned with respective ones of the additional plurality of partial bridge elements of the first screen panel to form at least one aperture in the vertical direction at an intersection of the first screen panel and the third screen panel.

In some implementations, the modular screen panel can define a plurality of apertures oriented in a plane that is substantially perpendicular to the additional screening apertures. For instance, in some implementations, the additional screening apertures can be oriented in a plane that is substantially perpendicular to a vertical direction, whereas the plurality of apertures can be oriented in a plane that is substantially parallel to the vertical direction. In this manner, material flowing through a corresponding aperture of the plurality of additional screening apertures can flow into the screen deck via a corresponding aperture of the plurality of apertures oriented in a plane that is substantially perpendicular to the plurality of additional screening apertures. In this manner, accumulation of material on the plurality of bridges extending from the screening surface can be prevented.

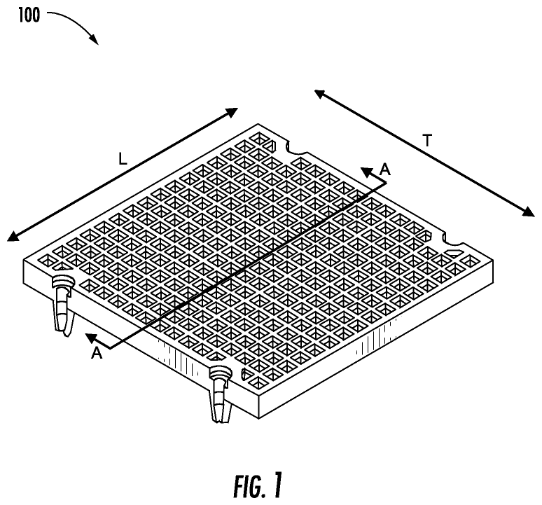

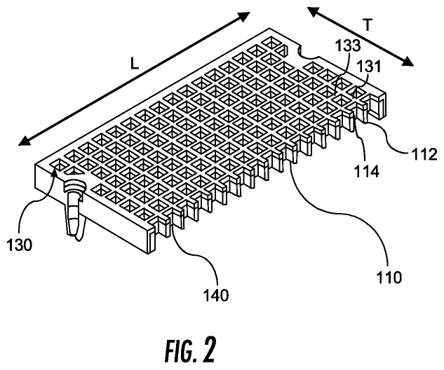

Referring now to FIGS. 1-4 depict an example screen panel 100 according to example embodiments of the present disclosure. The screen panel 100 can define a coordinate system that includes a lateral direction L, a transverse direction T, and a vertical direction V. The screen panel 100 can include a reinforcing polymer structure 110. In some implementations, the reinforcing polymer structure 110 can include a first group of bridge elements 112 extending along the transverse direction T and spaced apart from one another along the lateral direction L. Additionally, the reinforcing polymer structure 110 can include a second group of bridge elements 114 extending along the lateral direction L and spaced apart from one another along the transverse direction T. As shown, the first plurality of bridge elements 112 and the second plurality of bridge elements 114 can intersect with one another to define a plurality of openings. Although the reinforcing polymer structure 110 is depicted as having a rectangular shape, it should be appreciated that the reinforcing polymer structure 110 can be configured to have any suitable shape.

In some implementations, the reinforcing polymer structure 110 can be formed from any suitable type of polymer having a sufficiently high tensile strength or flexural modulus. In this manner, the stiffness and strength of both the first plurality of bridge elements 112 and the second plurality of bridge elements 114 can be improved. As a result, the dimensions (e.g. width) of the first plurality of bridge elements 112 and the second plurality of bridge elements 114 can be reduced.

As shown, the screen panel 100 can include a wear resistant polymer layer 130 bonded to the reinforcing polymer structure 110 such that the wear resistant polymer layer 130 at least partially covers the reinforcing polymer structure 110. For instance, in some implementations, the wear resistant polymer layer 130 can be bonded to a top portion of the reinforcing polymer structure 110. More specifically, the wear resistant polymer layer 130 can be bonded to a top surface of each of the first plurality of bridge elements 112. In addition, the wear resistant polymer layer 130 can be bonded to a top surface of each of the second plurality of bridge elements 114. As shown, the wear resistant polymer layer 130 can define a plurality of screening apertures 132. Each of the plurality of screening apertures 132 can be aligned with a corresponding opening of the plurality of openings 144 defined by the reinforcing polymer structure 110. It should be appreciated that a size and shape of the plurality of screening apertures 132 can be defined by the wear resistant polymer layer 130.

In some implementations, the wear resistant polymer layer 130 can also be bonded to the bottom portion of the reinforcing polymer structure 110. Alternatively or additionally, the wear resistant polymer layer 130 can be bonded to one or more sides of the reinforcing polymer structure 110 extending along the vertical direction V between the bottom portion and the top portion.

It should be understood that the wear resistant polymer layer 130 can be bonded to the reinforcing polymer structure 110 using any suitable bonding process. Example bonding processes can include mechanical adhesion, dispersive adhesion (e.g., Van Der Waals Forces), electrostatic adhesion, specific adhesion (e.g., hydrogen bonding), chemical adhesion (e.g., ionic or covalent bonding), diffusion adhesion (e.g., interdiffusion, entanglement, intermingling, or physical crosslinking). In some implementations, the reinforcing polymer structure 110 can be treated with a primer or bonding agent to facilitate bonding with the wear resistant polymer layer 130. Furthermore, the reinforcing polymer structure can be subjected to flame treatment, corona treatment, or plasma treatment to enhance bonding with the wear resistant polymer.

It should be understood that the wear resistant polymer layer can be formed from any suitable type of polymer known to resist wear imparted by the material being screened, such as abrasive wear and erosive wear. Polymers having such properties can be elastomeric with relatively low modulus values, high elongation capacity, and high resistance to tearing. Example polymers can include urethane elastomers or vulcanized rubbers. It should also be understood that one or more materials from which the wear resistant polymer layer 130 is formed are different than one or more materials from which the reinforcing polymer structure 110 is formed.

In some implementations, the wear resistant polymer layer 130 can define one or more fastener features 140. The one or more fastener features 140 can be used to secure the screen panel 100 to a support frame associated with a screening system. In this manner, the screen panel 100 can be secured to the support frame without requiring one or more additional components.

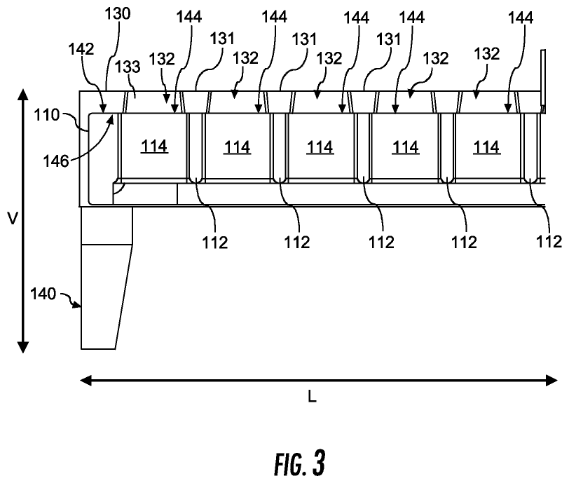

Referring to FIG. 3, the reinforcing structure 110 can have a top surface 142. The reinforcing structure 110 can define a plurality of apertures 144 through the reinforcing structure 110. The polymer layer 130 can have a bottom surface 146 that is arranged over the top surface 142 of the reinforcing structure 110. As indicated above, the polymer layer 130 can define a plurality of opening 132 or apertures therethrough. For example, the polymer layer 130 can include a first group of bridge elements 131 extending in the Transverse direction and a second group of bridge elements 133 extending in the Lateral direction. The first group of bridge elements 131 and second group of bridge elements 133 can define the apertures 132 of the polymer layer 130.

Each aperture 132 of the polymer layer 130 can be aligned with a single respective aperture 144 of the reinforcing structure 110. For example, the polymer layer 130 can cover all of the top surface 142 of the reinforcing structure 110. For example, the polymer layer 130 can cover all respective portions of the top surface 142 of the reinforcing structure 110 that are located on each bridge element 112 of the first group of bridge elements 112 and can cover all respective portions of the top surface 142 of the reinforcing structure located on each bridge element 114 of the second group of bridge elements 114. The reinforcing structure 110 can be bonded to the polymer layer 130 along respective portions of the top surface 142 of the reinforcing structure 110 that are located on each bridge element 112 of the first group of bridge elements 112.

In some embodiments, the reinforcing structure 110 can be bonded to the polymer layer 130. For example, the reinforcing structure 110 can be bonded to the polymer layer 130 along respective portions of the top surface 142 of the reinforcing structure 110 that are located on each bridge element 114 of the second group of bridge elements 114. However, in other embodiments the reinforcing structure 110 can be bonded to the polymer layer 130 along less than all of the top surface 142 of the reinforcing structure 110.

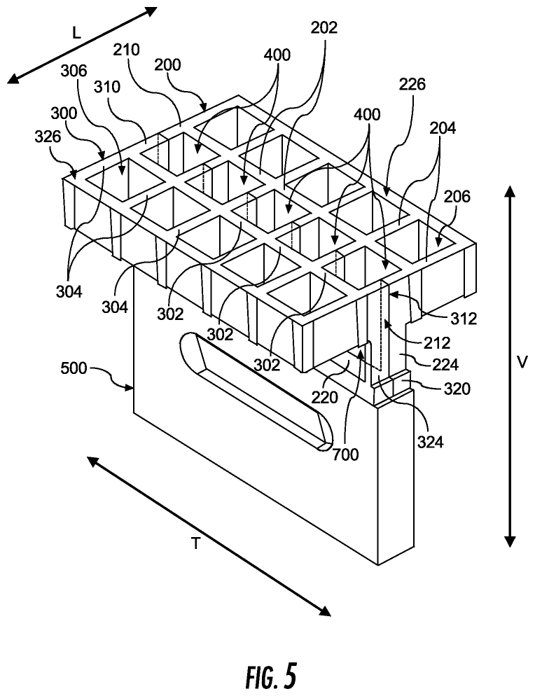

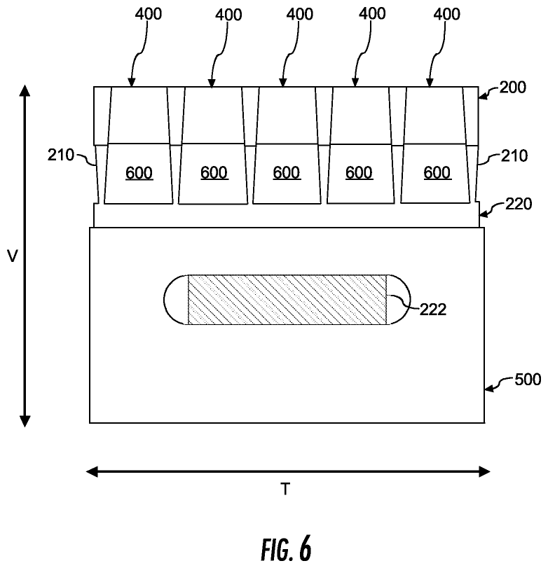

Referring now to FIGS. 5 through 7, a first screen panel 200 and a second screen panel 300 of a screening system are provided according to example embodiments of the present disclosure. The first screen panel 200 and the second screen panel 300 can each define a coordinate system including a lateral direction L, a transverse direction T, and a vertical direction V. As shown, the first screen panel 200 and the second screen panel 300 can each define a first group of bridge elements 202, 302 extending along the transverse direction T and spaced apart from one another along the lateral direction L. Additionally, the first screen panel 200 and the second screen panel 300 can each define a second group of bridge elements 204, 304 extending along the lateral direction L and spaced apart from one another along the transverse direction T. As shown, the first plurality of bridge elements 202, 302 and the second plurality of bridge elements 204, 304 can intersect with one another to define a plurality of screening apertures 206, 306 in the vertical direction, V.

In some implementations, the first screen panel 200 can include a plurality of partial bridge elements 210 extending away from the first screen panel 200 in the lateral direction L. For example, the plurality of partial bridge elements 210 can extend from a corresponding bridge element of the second group of bridge elements 204. Additionally, the plurality of partial bridge elements 210 can be spaced apart from one another along the transverse direction T. Furthermore, although the plurality of partial bridge elements 210 are depicted as defining only one side of the first screen panel 200, it should be understood that each of the remaining sides of the first screen panel 200 can be defined by the plurality of partial bridge elements 210. In this manner, the first screen panel 200 can be a borderless screen panel having a perimeter that is defined by the plurality of partial bridge elements 210.

In some implementations, the second screen panel 300 can include a plurality of partial bridge elements 310 extending away from the second screen panel 300 in the lateral direction L, For example, the plurality of partial bridge elements 310 can extend from respective corresponding bridge elements of the second group of bridge elements 304. Additionally, the plurality of partial bridge elements 310 can be spaced apart from one another along the transverse direction T. Furthermore, although the plurality of partial bridge elements 310 are only depicted as defining one side of the second screen panel 300, it should be understood that some or all of the remaining sides of the second screen panel 300 can be defined by the plurality of partial bridge elements 310. In this manner, the second screen panel 300 can be a borderless screen panel having a perimeter that is defined by the plurality of partial bridge elements 310. As will be discussed below in more detail, the first screen panel 200 and the second screen panel 300 can be positioned relative to one another such that each of the plurality of partial bridge elements 210 of the first screen panel 200 contacts (e.g., touches) a corresponding partial bridge element of the plurality of partial bridge elements 310 of the second screen panel 300. For example, respective end faces 312 of the plurality of partial bridge elements 310 of the second screen panel 300 can contact respective end faces 212 of respective ones of the plurality of partial bridge elements 210 of the first screen panel 200. Each of the plurality of partial bridge elements 310 of the second screen panel 300 can be aligned with respective ones of the plurality of partial bridge elements 210 of the first screen panel 200 such that a plurality of apertures 400 are formed at the intersection of the first screen panel 200 and the second screen panel 300.

The plurality of partial bridge elements 210, 310 of the first screen panel 200 and the second screen panel 300, respectively, define one or more screening apertures 400 an intersection of the first screen panel 200 and the second screen panel 300. In this manner, the first screen panel 200 and the second screen panel 300 can have the appearance of a single screen panel (e.g., along an intersection of the first screen panel 200 and the second screen panel 300).

As shown, each of the plurality of screening apertures 400 can be defined along the lateral direction L between a corresponding bridge element of the second group of bridge elements 204, 304 of the first panel 200 and the second panel 300, respectively. Each of the plurality of screening apertures 400 can be further defined along the transverse direction T between adjacent partial bridge elements 210, 310 of the plurality of partial bridge elements 210, 310 of the first screen panel 200 and the second screen panel 300, respectively.

For instance, perpendicular edges of the same screen panel can define partial bridge elements such that apertures are formed between the screen panel and multiple other screen panels. For example, the first screen panel can include an additional plurality of partial bridge elements extending away from the first screen panel in a transverse direction from an additional edge of the plurality of edges. The transverse direction can be perpendicular to each of the lateral direction and a vertical direction. A third screen panel can include a plurality of partial bridge elements aligned with respective ones of the additional plurality of partial bridge elements of the first screen panel to form at least one aperture in the vertical direction at an intersection of the first screen panel and the third screen panel.

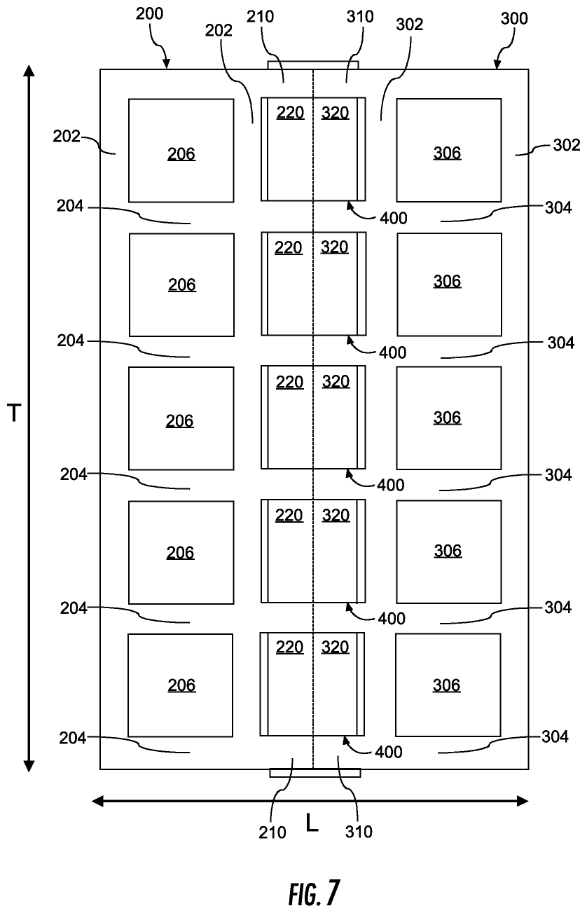

Referring to FIG. 7, the plurality of partial bridge elements 210 of the first screen panel 200 can define a portion of a perimeter of the first screen panel when viewed from the vertical direction V. The plurality of partial bridge elements 310 of the second screen panel 300 can define a portion of a perimeter of the second screen panel 300 when viewed from the vertical direction.

Referring to FIGS. 5-7, in some embodiments, the first screen panel 200 or the second screen panel 300 can include a frame member 220 configured to support the first screen panel 200 and/or the second panel 300 at the intersection of the first screen panel 200 and second screen panel 300. The frame member 220 may be configured to support the first screen panel 200 and/or the second screen panel 300 in a manner that does not block the apertures 400 at the intersection of the first screen panel 200 and the second screen panel 300. Rather, the first screen panel 200 and second screen panel 300 can be structured such that material particles can pass through the apertures 400 at the intersection of the first screen panel 200 and the second screen panel 300 in the vertical direction, V.

For example, in some implementations, each of the plurality of partial bridge elements 210 of the first screen panel 200 can extend along the vertical direction V to a frame member 220 of the first screen panel 200. Likewise, each of the plurality of partial bridge elements 310 of the second screen panel 300 can extend along the vertical direction V to a frame member 320 of the second screen panel 300. In some implementations, the frame member 220 of the first screen panel 200 and the frame member 320 of the second screen panel 300 can each be coupled to a support structure 500 (e.g., deck) of the screening system. For instance, in some implementations, the frame member 220 of the first screen panel 200 and the frame member 320 of the second screen panel 300 can each include a projection or feature 222, 322 configured to engage a corresponding projection or feature (not shown) of the support structure 500.

For example, referring to FIG. 5, some or all of the plurality of partial bridge elements 210 of the first screen panel 200 can include respective downward extending portions 224 that extend downward in the vertical direction away from a top surface 226 of the first screen panel 200 and connect with the frame member 220 to form one or more lateral apertures 600, 700 at the intersection of the first screen panel 200 and the second screen panel 300. Similarly, some or all of the partial bridge elements 310 of the second screen panel 300 can include respective downward extending portions 324 that extend downward in the vertical direction away from a top surface 326 of the first screen panel 200 and connect with the frame member 320 to form one or more lateral apertures 600, 700 at the intersection of the first screen panel 200 and the second screen panel 300. However, it should be understood that, in some embodiments only one of the first screen panel 200 and the second screen panel 300 can include downward extending portions. In such embodiments, the panel that does include downward extending portions can rest on the panel that does include such downward extending portions.

Referring to FIGS. 5-7, when the frame member 220 of first screen panel 200 and the frame member 320 of the second screen panel 300 are each coupled to the support structure 500, it should be appreciated that each of the plurality of screening apertures 400 defined, at least in part, by corresponding partial bridge elements 210, 310 of the first screen panel 200 and the second screen panel 300, respectively, are spaced apart from the support structure 500 along the vertical direction V. As will be discussed below in more detail, the first screen panel 200 and the second screen panel 300 can each define a plurality of apertures configured to allow material flowing through a corresponding screening aperture of the plurality of screening apertures 400 to flow into a deck (not shown) positioned below the first and second panels 200, 300 and defined, at least in part, by the support structure 500.

In some implementations, the first screen panel 200 and the second screen panel 300 can each define a plurality of lateral apertures 600, 700 oriented in a plane that is substantially perpendicular to a plane in which the plurality of screening apertures 400 defined by the plurality of partial bridge elements 210, 310 of the first screen panel 200 and the second screen panel 300, respectively, is oriented. For instance, the plurality of screening apertures 400 can be oriented in a plane that is substantially perpendicular to the vertical direction V. Conversely, the plurality of lateral apertures 600, 700 can be oriented in a plane that is substantially parallel to the vertical direction V.

As shown, each of the plurality of lateral apertures 600 of the first screen panel 200 can be defined along the vertical direction V between the frame member 220 and a corresponding bridge element of the second group of bridge elements 204. Furthermore, each of the plurality of lateral apertures 600 of the first screen panel 200 can be defined along the transverse direction T between adjacent partial bridge elements of the plurality of partial bridge elements 210 of the first screen panel 200. It should be appreciated that each of the plurality of apertures 700 of the second screen panel 300 can be defined along the vertical direction V between the frame member 320 and a corresponding bridge element of the second group of bridge elements 304. It should also be appreciated that each of the plurality of apertures 700 of the second screen panel 300 can be defined along the transverse direction T between adjacent partial bridge elements of the plurality of partial bridge elements 310 of the second screen panel 300. As such, material that flows through the one of the plurality of screening apertures 400 can flow into the screen deck (not shown) via a corresponding aperture of the plurality of lateral apertures 600, 700 defined by the first screen panel 200 and the second screen panel 300, respectively. In this manner, accumulation of the material on the frame member 220 of the first screen panel 200 or the frame member 320 of the second screen panel 300 can be avoided.

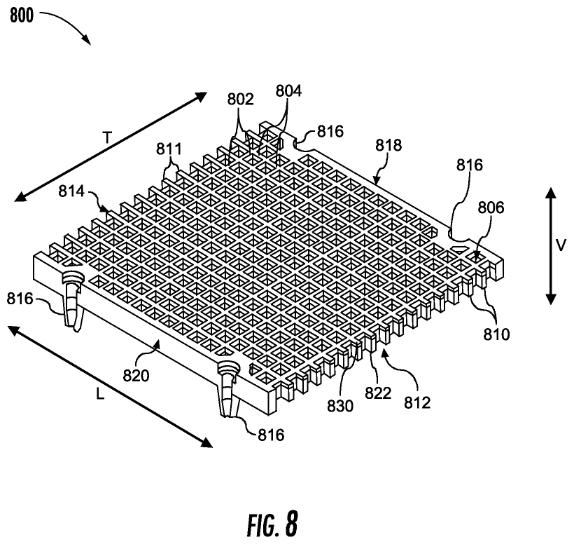

FIG. 8 illustrates an embodiment of screen panel 800 according to aspects of the present disclosure. The screen panel 800 can define a plurality of apertures 806 in the vertical direction. For example, the screen panel 800 can include a plurality of bridge elements 802 that are aligned with the Lateral direction and a plurality bridge elements 804 that are aligned with the Transverse direction to form the plurality of apertures 806. The screen panel 800 can include a first plurality of partial bridge elements 810 along a first edge 812 of the screen panel 800. The screen panel 800 can include a second plurality of partial bridge elements 811 along a second edge 814. The second edge 814 can be parallel with and opposite the first edge 812 such that a continuous strip of apertures 806 can be formed be arranged consecutive screening panels 800 adjacent each other, for example, in a manner described above with reference to FIGS. 5 through 7. However, it should be understood that, in other embodiments, the second edge 814 can be perpendicular to the first edge 812 or at any suitable angle. For example, the screen panel 800 can have a range of numbers of sides. For instance, the screen panel 800 can have three sides or five or more sides (e.g., a honeycomb configuration). Thus, it should be understood that the screen panel 800 illustrated by FIG. 8 is merely an example embodiment according to aspects of the present disclosure.

The screen panel 800 can include one or more vertical support members 816 configured to support the screen panel 800. The vertical support members 816 can be disposed along one or more support edges 818, 820. For example, the support edges 818, 820 to which the vertical support members 816 are coupled can be distinct from the first and second edges 812, 814. For instance, the support edges 818, 820 can be perpendicular to one or both of the first edge 812 and the second edge 814. However, it should be understood that the screen panel can additionally or alternatively be supported along the first and second edges 812, 814, which include partial bridge members 810, 811, for example as described above with respect to the vertical portions 224, 324 and/or frame members 220, 320 of FIGS. 5 through 7.

In some embodiments, the screen panel 800 can include a reinforcing structure 822 having a top surface. The reinforcing structure 822 can define a plurality of apertures (corresponding with the apertures 806) through the reinforcing structure 822. The screen panel 800 can include a polymer layer 830 having a bottom surface that is arranged over the top surface of the reinforcing structure 822, for example as described above with respect to the top surface 142 of the reinforcing structure 110 and the bottom surface 146 of the polymer layer 130 of FIG. 1-4. The polymer layer 130 can cover the top surface of the reinforcing structure 822 and/or cover all respective top surfaces of bridge elements of the polymer layer 830, for example as described with respect to FIGS. 1-4. The polymer layer 830 can define a plurality of apertures therethrough (corresponding with apertures 806). Each aperture 806 of the polymer layer 830 can be aligned with a single respective aperture 806 of the reinforcing structure 822.

As explained herein, apertures of conventional screen panels may periodically experience issues with plugging or clogging of the apertures. For example, when a larger piece of aggregate material is unable to pass completely through the aperture, it may become stuck in the surface, thereby reducing the screening area, backing up screening material, reducing screening efficiency, and generally negating the benefits of the high open area screening panels described herein. In addition, operators may be required to manually remove clogs from the screen panel or replace the panels altogether. Accordingly, aspects of the present subject matter are generally directed to features of screen panels that reduce the likelihood or severity of clogs and improve screening efficiency.

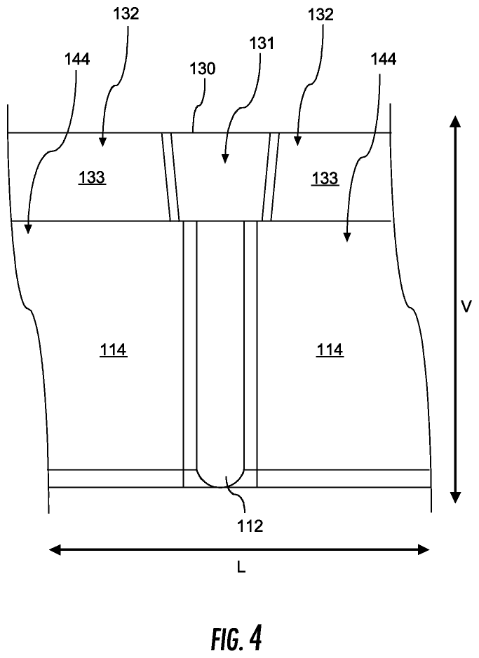

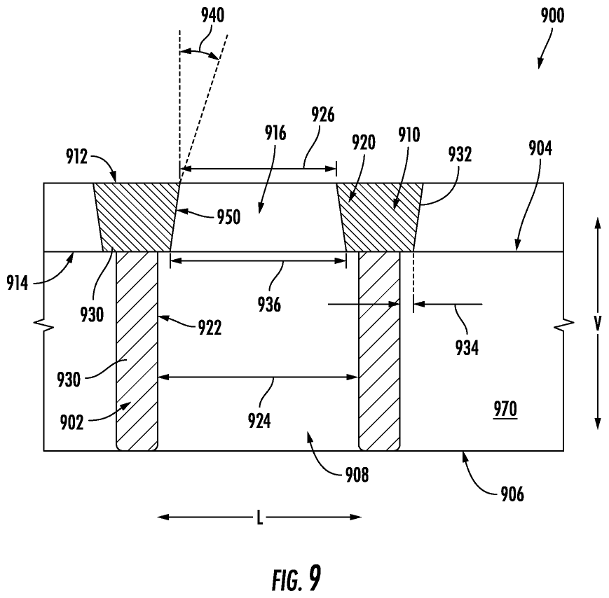

For example, referring now specifically to FIG. 9, a screen panel 900 will be described according to an example embodiment of the present subject matter. Notably, screen panel 900 may be the same or similar to screen panel 100 and features between embodiments may be interchangeable to form still other embodiments considered to be within the scope of the present subject matter. For example, screen panel 900 as illustrated in FIG. 9 may be a close-up cross sectional view of screen panel 100 as shown in FIGS. 3 and 4. Due to the similarity between embodiments, like reference numerals may be used to refer to the same or similar features among embodiments.

As shown, screen panel 900 includes a reinforcing structure 902 that generally defines a top surface 904 that is spaced apart from a bottom surface 906 along the vertical direction V. In general, reinforcing structure 902 may define a plurality of reinforcement apertures 908 that extend through reinforcing structure 902 along the vertical direction V from top surface 904 to bottom surface 906. As explained above, reinforcement apertures 908 are generally configured for passing particles of a particular shape or size during a screening process.

In addition, screen panel 900 may generally include a polymer layer 910 that generally comprises a resilient material, as described above. In general, polymer layer 910 may define a top surface or screening surface 912 that is spaced apart from a bottom surface 914 along the vertical direction V. Similar to reinforcing structure 902, polymer layer 910 may also define a plurality of panel apertures 916 that extend through polymer layer 910 along the vertical direction V from screening surface 912 to bottom surface 914. Notably, as explained above, polymer layer 910 may generally be supported by reinforcing structure 902. For example, at least a portion of bottom surface 914 of polymer layer 910 may be supported by top surface 904 of reinforcing structure 902. In addition, panel apertures 916 may generally be aligned with reinforcement apertures 908 such that screening material may pass through screen panel 100 along the vertical direction V.

Notably, as explained above, polymer layer 910 is generally formed from a more resilient or softer material than reinforcing structure 902. Accordingly, if reinforcement apertures 908 and panel apertures 916 are the same size, it is possible that a stone or another piece of aggregate material may pass through panel apertures 916 (e.g., due to the more resilient material of polymer layer 910) while becoming lodged within reinforcement apertures 908 (e.g., due to more rigid material of reinforcing structure 902). Accordingly, aspects of the present subject matter include varying the cross sectional area (e.g., defined in a horizontal plane corresponding to the lateral direction L and the transverse direction T) of panel apertures 916 relative to reinforcement apertures 908 in a manner that reduces the likelihood of panel clogging or plugging.

Specifically, according to the illustrated embodiment, polymer layer 910 may further define an overhang portion 920 that extends at least partially beyond an edge 922 of reinforcing structure 902 in a manner that modifies the cross-sectional area of panel apertures 916. Specifically, as best illustrated in FIG. 9, reinforcement aperture may generally define a reinforcement aperture width 924 that is generally measured in a horizontal direction (e.g., the lateral direction L in FIG. 9) between adjacent bridge elements of reinforcing structure 902 (e.g., such as between first bridge elements 112). In addition, panel apertures 916 may generally define an aperture entry width 926 that is generally measured in a horizontal direction across panel apertures 916. As shown, overhang portion 920 may reduce the cross-sectional area of panel apertures 916 relative to reinforcement apertures 908, such that aperture entry width 926 is less than reinforcement aperture width 924.

Notably, an exemplary overhang portion 920 will be described herein according to an example embodiment. However, it should be appreciated that the geometry and construction of overhang portion 920 may vary while remaining within the scope of the present subject matter. The scope of the present subject matter is not intended to be limited to the specific structure described. As shown, overhang portion 920 may generally include an overhang edge 930 that extends within a horizontal plane (e.g., the lateral direction L in FIG. 9) beyond edge 922 of reinforcing structure 902. In addition, overhang portion 920 may define an aperture wall 932 that extends from overhang edge 930 upward along the vertical direction V. In other words, aperture wall 932 may generally be the surface of polymer layer 910 that defines the boundaries of panel apertures 916 and may generally extend along the vertical direction V between bottom surface 914 and screening surface 912 of polymer layer 910.

In general, the overhang edge 930 may generally define an overhang width 934 that is measured as a distance within a horizontal plane from edge 922 of reinforcing structure 902 to the intersection of overhang edge 930 and aperture wall 932. According to the illustrated embodiment, overhang edge 930 extends directly in the lateral direction L. However, it should be appreciated that overhang edge 930 may be angled up or down depending on the application while remaining within the scope of the present subject matter. In addition, overhang width 934 may vary while remaining within scope the present subject matter. According to example embodiments, overhang width 934 may be between about 0 and 20 mm, between about 0.5 and 10 millimeters, between about 1 and 5 millimeters, or about 3 millimeters.

In general, overhang edge 930 may extend inward along the lateral direction L to define an aperture exit width 936 (e.g., measured along the lateral direction L at the location where aggregate would exit panel apertures 916). In general, aperture exit width 936 may be less than reinforcement aperture width 924 and greater than aperture entry width 926. In this manner, the screening apertures formed from panel apertures 916 and reinforcement apertures 908 may increase the cross-sectional area between screening surface 912 and a bottom surface 906 of reinforcing structure 902.

Referring still to FIG. 9, aperture wall 932 may further define a relief angle 940 that is measured relative to the vertical direction V. In general, forming aperture wall 932 such that it has a relief angle may reduce the likelihood of plugging or clogging due to the increased cross-sectional area between screening surface 912 and bottom surface 914 of polymer layer 910. According to an example embodiment, relief angle 940 may generally be between about 0° and 30°, between about 1° and 10°, between about 2° and 4°, or about 3°. It should be appreciated that the relationship between overhang width 934 and relief angle 940 may selected based on the type or size of aggregate being screened, where increases in overhang width 934 and relief angle 940 generally increase the expansion angle of screening aperture.

Notably, by adjusting the geometries described above, a relief ratio may be associated with each screening aperture of screen panel 900. In this regard, the relief ratio may be defined as the aperture entry width 926 of polymer layer 910 over the reinforcement aperture width 924. In general, the relief ratio may thus be a metric associated with how quick the screening apertures expand and the associated reduction in the likelihood of clogging. In general, the relief ratio may be between about 0.75:1 and 0.95:1, between about 0.8:1 and 0.9:1, or about 0.85:1. Other relief ratios are possible and within the scope of the present subject matter.

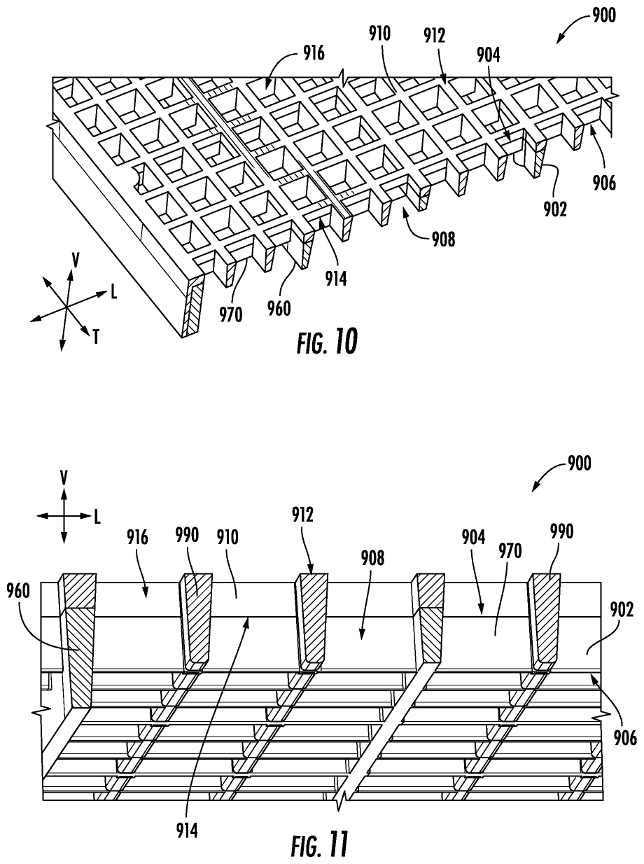

Referring now specifically to FIGS. 10 through 12, the reinforcing structure 902 will be described according to an example embodiment of the present subject matter. Notably, due to the rigid nature of reinforcing structure 902, if every panel aperture 916 is fully surrounded by reinforcing structure 902, the likelihood of plugging or clogging may increase. Accordingly, the reinforcing structure 902 illustrated in FIGS. 10 through 12 may provide sufficient structural support to screen panel 900 while providing improved flexibility or resiliency of panel apertures 916.

Specifically, as shown, each panel aperture 916 of polymer layer 910 may generally define an aperture perimeter (e.g., the perimeter of panel apertures 916 as defined in a horizontal plane). For ease of reference, the vertical location of aperture perimeter 950 used herein may be at bottom surface 914 of polymer layer 910 (e.g., also corresponding to the polymer layer aperture exit). In addition, reinforcing structure 902 includes top surface 904 for supporting at least a portion of bottom surface 914 of polymer layer 910. Notably, according to example embodiments, reinforcing structure 902 is positioned under polymer layer 910 along only a portion of aperture perimeter 950 of each panel aperture 916.

In other words, reinforcing structure 902 may be constructed such that is not positioned under every portion of polymer layer 910 or otherwise does not directly support polymer layer at that location around panel aperture 916. While reinforcing structure 902 may generally be positioned under polymer layer 910 and may technically “support” polymer layer 910, it should be appreciated that these terms may be used herein to refer to the localized support around the perimeter of panel aperture 916.

For example, according to an embodiment, panel apertures 916 may include a plurality of distinct aperture sides and reinforcing structure 902 is positioned under fewer than all of the plurality of aperture sides. More specifically, according to the illustrated embodiment, aperture perimeter 950 may generally include four sides (e.g., panel apertures 916 may generally be rectangular or square). According to such an embodiment, no more than three sides or no more than two sides of aperture perimeter 950 may be locally supported by reinforcing structure 902. Indeed, according to example embodiments, at least one aperture of the plurality of panel apertures 916 may not have any reinforcing structure 902 positioned under any sides of that aperture. For example, as shown in FIG. 12, certain interior apertures of panel apertures 916 may not have any directly adjacent reinforcing structure 902.

It should be appreciated that various geometries, shapes, and sizes may be used for reinforcing structure 902. Although an exemplary reinforcement structure is described below, it should be appreciated that variations and modifications to reinforcing structure 902 may be made while remaining within the scope of the present subject matter. Specifically, as shown in FIGS. 10 through 12, reinforcing structure 902 may generally include a plurality of primary bridges 960 that extend along a first direction (e.g., the transverse direction T in FIG. 12) between a first panel edge 962 and a second panel edge 964. In addition, reinforcing structure 902 may generally include a plurality of secondary bridges 970 that extend along a second direction (e.g., the lateral direction L in FIG. 12) between a third panel edge 972 and a fourth panel edge 974.

In general, the spacing between primary bridges 960 and secondary bridges 970 may vary depending on the application, e.g., based on the type of polymer material, based on the type of aggregate being screened, etc. According to an exemplary embodiment, a primary bridge spacing 980 is defined between adjacent bridges of the plurality of primary bridges 960 and a secondary bridge spacing 982 is defined between adjacent bridges of the plurality of secondary bridges 970. According to the illustrated embodiment, primary bridge spacing 980 may be the same or similar to secondary bridge spacing 982 (e.g., such that a grid of square screening areas is defined). By contrast, according to alternative embodiments, primary bridge spacing 980 may be different than secondary bridge spacing 982 (e.g., such that a grid of rectangular screening areas is defined).

In addition, it should be appreciated that the bridge spacing may be a variable as needed depending on the application. For example, if one side of screen panel 910 is expected to experience higher aggregate volumes or to get more wear, primary bridge spacing 980 and/or secondary bridge spacing 982 may be tighter in that area to provide improved support. Moreover, according to example embodiments, reinforcing structure 902 may omit one or both of primary bridges 960 and secondary bridges 970. In addition, it should be appreciated that the bridge spacing may be defined relative to a width of panel apertures 916. For example, panel apertures 916 may generally define an aperture entry width 926, and the primary bridge spacing 980 or the secondary bridge spacing 982 may be 2 times, 4 times, 10 times, or greater than aperture entry width 926.

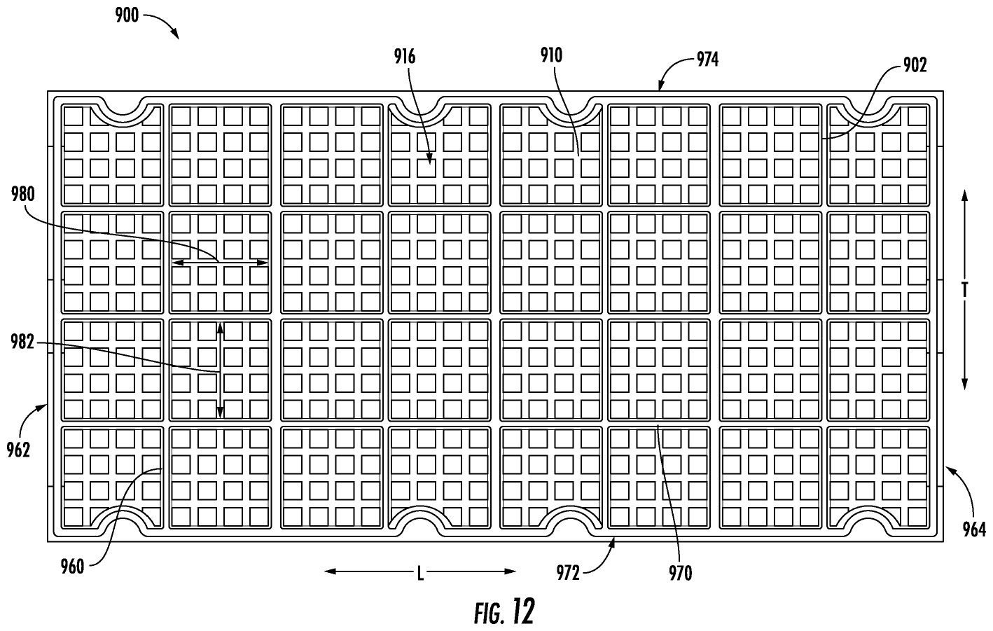

Notably, referring now specifically to FIG. 11, it may be desirable to increase the height of polymer layer 910 in locations where reinforcement structure 302 is not positioned under polymer layer 910. In this regard, polymer layer 910 may include extended polymer bridges 990 at locations where reinforcing structure 902 is not positioned under polymer layer 910. In general, polymer bridges 990 may extend below top surface 904 of reinforcing structure and 902 and may be designed to have a similar geometry to portions of screen panel 900 that include both reinforcing structure 302 and polymer layer 910. Notably, this may improve the screening efficiency while also reducing issues related to molding or manufacturing screen panels 900.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A screen panel for a vibratory machine, the screen panel comprising:
a polymer layer comprising a resilient material and defining a plurality of panel apertures extending through the polymer layer from an upper screening surface to a bottom surface of the polymer layer, each of the plurality of panel apertures defining an aperture perimeter; and
a reinforcing structure having a top surface that supports at least a portion of the bottom surface of the polymer layer, wherein the reinforcing structure is positioned under the polymer layer along only a portion of the aperture perimeter of each of the plurality of panel apertures.

2. The screen panel of claim 1, wherein each of the plurality of panel apertures defines a plurality of aperture sides, and wherein the reinforcing structure is positioned under fewer than all of the plurality of aperture sides.

3. The screen panel of claim 1, wherein the aperture perimeter comprises four sides, and wherein the reinforcing structure is positioned under no more than three sides of the four sides of each of the aperture perimeter.

4. The screen panel of claim 1, wherein the aperture perimeter comprises four sides, and wherein the reinforcing structure is positioned under no more than two sides of the four sides of each of the aperture perimeter.

5. The screen panel of claim 1, wherein at least one aperture of the plurality of panel apertures does not have reinforcing structure positioned under any sides defining the at least one aperture.

6. The screen panel of claim 1, wherein at least a portion of the polymer layer extends below the top surface of the reinforcing structure.

7. The screen panel of claim 1, wherein the reinforcing structure comprises:
a plurality of primary bridges that extend along a lateral direction from a first panel edge to a second panel edge; and
a plurality of secondary bridges that extend along a transverse direction from a third panel edge to a fourth panel edge.

8. The screen panel of claim 7, wherein a primary bridge spacing is defined between adjacent bridges of the plurality of primary bridges and a secondary bridge spacing is defined between adjacent bridges of the plurality of secondary bridges, wherein the primary bridge spacing is different than the secondary bridge spacing.

9. The screen panel of claim 7, wherein a primary bridge spacing is defined between adjacent bridges of the plurality of primary bridges and a secondary bridge spacing is defined between adjacent bridges of the plurality of secondary bridges, wherein the primary bridge spacing is variable between the first panel edge and the second panel edge or the secondary bridge spacing is variable between the third panel edge and the fourth panel edge.

10. The screen panel of claim 7, wherein a primary bridge spacing is defined between adjacent bridges of the plurality of primary bridges, a secondary bridge spacing is defined between adjacent bridges of the plurality of secondary bridges, and each of the plurality of panel apertures defines an aperture width, wherein at least one of the primary bridge spacing or the secondary bridge spacing is two times or greater than the aperture width.

11. The screen panel of claim 1, wherein the polymer layer covers all of the top surface of the reinforcing structure.

12. The screen panel of claim 1, wherein the reinforcing structure is bonded to the polymer layer.

13. A screen panel for a vibratory machine, the screen panel comprising:
a reinforcing structure having a top surface and a reinforcement aperture defined therethrough, the reinforcement aperture defining a reinforcement aperture width; and
a polymer layer comprising a resilient material and having a bottom surface that is arranged over the top surface of the reinforcing structure, wherein the polymer layer has a panel aperture defined therethrough, the panel aperture defining an aperture entry width, and wherein the polymer layer further defines an overhang portion that extends at least partially beyond an edge of the reinforcing structure such that the aperture entry width is less than the reinforcement aperture width.

14. The screen panel of claim 13, wherein the overhang portion comprises an overhang edge that extends along a lateral direction beyond the edge of the reinforcing structure and an aperture wall that extends from the overhang edge upward along a vertical direction to a screening surface of the polymer layer.

15. The screen panel of claim 14, wherein the overhang edge extends to define an aperture exit width, the aperture exit width being less than the reinforcement aperture width and greater than the aperture entry width.

16. The screen panel of claim 14, wherein the aperture wall defines a relief angle measured relative to the vertical direction.

17. The screen panel of claim 16, wherein the relief angle is between 1 degree and 10 degrees.

18. The screen panel of claim 14, wherein the overhang edge defines an overhang width, the overhang width being between 1 millimeter and 5 millimeters.

19. The screen panel of claim 13, wherein a relief ratio is defined as the aperture entry width over the reinforcement aperture width, wherein the relief ratio is between 0.75:1 and 0.95:1.

20. The screen panel of claim 19, wherein the relief ratio is 0.85:1.
